(19) United States
(12) Patent Application Publication
(10) Pub. No.: US 2018/0287134 A1
(43) Pub. Date: Oct. 4, 2018

(54) COMPOSITE ELECTRODE INCLUDING MICROPOROUS IONICALLY CONDUCTING MATERIAL, COMPOSITE SLURRY, AND METHODS OF MANUFACTURING SAME

(71) Applicant: Sharp Kabushiki Kaisha, Osaka (JP)

(72) Inventors: Daniela LEDWOCH, Oxford (GB); Emma KENDRICK, North Warnborough (GB); Paul ADAMSON, Oxford (GB)

(21) Appl. No.: 15/475,701

(22) Filed: Mar. 31, 2017

(51) Int. Cl. H01M 4/131; H01M 4/136; H01M 4/133; H01M 4/134; H01M 4/1391; H01M 4/1393; H01M 4/1395; H01M 4/1397; H01M 4/525; H01M 4/505; H01M 4/58; H01M 4/587; H01M 4/38; H01M 4/62; H01M 4/66; H01M 4/04; H01M 10/0525; H01M 10/054

(52) U.S. Cl. CPC H01M 4/131; H01M 2004/027; H01M 4/133; H01M 4/134; H01M 4/1391; H01M 4/1393; H01M 4/1395; H01M 4/1397; H01M 4/525; H01M 4/505; H01M 4/5815; H01M 4/587; H01M 4/387; H01M 4/386; H01M 4/623; H01M 4/625; H01M 4/661; H01M 4/0404; H01M 4/0409; H01M 10/0525; H01M 10/054; H01M 4/136

(57) ABSTRACT

A composite electrode includes: a conductive matrix including an electrically conductive material and a binder; an active electrode material dispersed in the conductive matrix; and a microporous ionically conducting solid dispersed in the conductive matrix. In some embodiments, the composite electrode is formed from a composite slurry, including: a solvent; a conductive matrix dispersed in the solvent, the conductive matrix including an electrically conductive material and a binder; an active electrode material dispersed in the solvent; and a microporous ionically conducting solid dispersed in the solvent.

### TECHNICAL FIELD

The present disclosure relates to a composite electrode including a positive or negative active electrode material, an electrically conductive material, and a microporous ionically conducting material; a composite slurry including a positive or negative electrode active material, an electrically conductive material, and a microporous ionically conducting material; and the manufacture thereof. The present disclosure also relates to the use of the composite electrode and/or composite slurry, for example, in rechargeable batteries and other energy storage devices.

### BACKGROUND ART

Metal ion batteries, in particular lithium ion batteries, are energy storage devices which have a wide array of applications. Two preferred applications are portable battery technologies for electronic devices and automotive. Both of these applications require high energy density battery systems. An emerging market for metal ion batteries is in stationary energy storage where energy density is not a key driver but cost and cycle life is.

Sodium-ion batteries are similar to lithium-ion batteries in that they are reusable secondary batteries that include an anode (negative electrode), a cathode (positive electrode) and an electrolyte material. Lithium- and sodium-ion batteries are both capable of storing energy, and they both charge and discharge via a similar reaction mechanism. When a sodium-ion (or lithium-ion) battery is charging, Na⁺ (or Li⁺) ions de-intercalate from the cathode and insert into the anode. Consequently, charge balancing electrons pass from the cathode through the external circuit and into the anode of the battery. During discharge, the same process occurs but in the opposite direction.

For applications where cost is a key driver, sodium-ion batteries may offer a viable alternative to lithium-ion batteries. Lithium is not an abundant metal and is becoming more costly to source, whereas sodium is much more abundant than lithium. Some researchers predict that sodium-ion batteries will provide a cheaper and more sustainable technology by which to store energy into the future, particularly for large scale applications such as storing energy on the electrical grid or domestic energy storage. Nevertheless, significant developments are required in terms of materials, operating voltage, specific capacity, material stability and energy efficiency before sodium-ion batteries become competitive with existing energy storage technologies.

U.S. Pat. No. 9,054,373 B2 (Abouimrane et al, published Jun. 9, 2015) discloses that composites of a metal oxide and a metal carbon alloy can buffer the volume expansion associated with lithium alloying of metal oxides. The metal composites minimize the poor conductivity effect of Li₂O forming during the conversion reaction of the metal oxide with lithium. Good cycling performance is observed with the material prepared by the mixing of tin cobalt carbon alloys and a metal oxide material.

International Application Publication No. WO 2010/138760 A2 (Manthiram et al., published Dec. 2, 2010) discloses a Sb-MOₓ—C nanostructured anode composition exhibiting excellent capacity retention with high capacity and rate capability having a Sb-MOₓ—C anode composition that alleviates the volume expansion encountered with alloy anodes during the charge-discharge process, wherein x is between 0.1 and 3 and M is selected from the group consisting of Al, Mg, Ti, V, Cr, Mn, Fe, Co, Ni, Zr, Mo, W, Nb, Ta, or combinations thereof. In some embodiments, the Sb-MOₓ—C anode composition having Al₂O₃, TiO₂, MoO₃

International Application Publication No. WO2016/080589 A1 (Jeong et al., published May 26, 2016) discloses an electrode active material containing a zeolite ion-exchanged with lithium, or a lithium insertion compound oxide, and a lithium ion; and an electrode formed therefrom.

U.S. Pat. No. 9,196,902 B2 (Kallfass et al., published Nov. 24, 2015) discloses the use of new crystalline phosphate- and silicate-based electrode materials, preferably having a hopeite or zeolite lattice structure, which are suitable more particularly for lithium-ion batteries and lithium capacitors based on non-aqueous systems.

International Application Publication No. WO 2015033038 A1 (Schmidt, published Mar. 12, 2015) discloses organic salt additives for improving the ionic conductivity of lithium-ion battery electrodes. A composite electrode material includes: an electronically conductive additive, such as carbon; an active material that is an oxide, a phosphate, a fluorophosphate or a silicate of lithium; a polymer binder such as PVDF; and an organic salt corresponding to defined chemical formulae, for example LiPDI, LiTDI, LiPDCI, LiDCTA, LiFSI, LiTFSI, optionally as a mixture. The organic salt makes it possible to increase the ionic conductivity of the electrode.

Chinese Patent Application Publication No. CN 103887473 A (Chuntai et al., published Jun. 25, 2014) discloses a negative electrode with a surface coated with lithiated zeolite, and a lithium-ion battery using the negative electrode.

### CITATION LIST

U.S. Pat. No. 9,054,373 B2 (Abouimrane et al, published Jun. 9, 2015)
WO 2010/138760 A2 (Manthiram et al., published Dec. 2, 2010)
WO2016/080589 A1 (Jeong et al., published May 26, 2016)
U.S. Pat. No. 9,196,902 B2 (Kallfass et al., published Nov. 24, 2015)
WO 2015033038 A1 (Schmidt, published Mar. 12, 2015)
CN 103887473 A (Chuntai et al., published Jun. 25, 2014)

### SUMMARY OF INVENTION

In accordance with one aspect of the present disclosure,

a composite electrode includes: a conductive matrix, including: an electrically conductive material and a binder; an active electrode material dispersed in the conductive matrix; and a microporous ionically conducting solid dispersed in the conductive matrix.

In some embodiments, the active electrode material includes a lithium or sodium layered oxide, layered phosphate, or layered sulfate.

In some embodiments, the active electrode material includes silicon, germanium, tin, metal oxide, metal sulphide, hard carbon, graphite, antimony, nickel-tin, or tin-antimony.

In some embodiments, the active electrode material is present in an amount of 50 wt % to 95 wt % of the composite electrode.

In some embodiments, the microporous ionically conducting solid includes a zeolite.

In some embodiments, the microporous ionically conducting solid includes a clathrate.

In some embodiments, the microporous ionically conducting solid includes porous nano silica.

In some embodiments, the microporous ionically conducting solid includes porous nano alumina.

In some embodiments, the microporous ionically conducting solid includes a molecular organic framework material.

In some embodiments, the microporous ionically conducting material is present in an amount of 0.1 wt % to 10 wt % of the composite electrode.

In some embodiments, the binder includes poly vinylidene fluoride (PVDF), poly vinyl chloride (PVC) poly acrylic acid (PAA), polyvinylpyrrolidone (PVP), polyvinyl alcohol (PVA), polyvinyl acetate, ethylene propylene diene monomer (EPDM), polyethylene oxide (PEO), styrene butyl rubber (SBR) or water soluble binder such as alginates or carboxymethyl cellulose (CMC).

In accordance with another aspect of the present disclosure, a composite slurry includes: a solvent; a conductive matrix dispersed in the solvent, the conductive matrix including: an electrically conductive material; and a binder; an active electrode material dispersed in the solvent; and a microporous ionically conducting solid dispersed in the solvent.

In some embodiments, the active electrode material includes a lithium or sodium layered oxide, layered phosphate, or layered sulfate.

In some embodiments, the active electrode material includes silicon, germanium, tin, metal oxide, metal sulphide, hard carbon, graphite, antimony, nickel-tin, or tin-antimony.

In some embodiments, the microporous ionically conducting solid includes a zeolite.

In some embodiments, the microporous ionically conducting solid includes a clathrate.

In some embodiments, the binder includes poly vinylidene fluoride (PVDF), poly vinyl chloride (PVC) poly acrylic acid (PAA) polyvinylpyrrolidone (PVP), polyvinyl alcohol (PVA), polyvinyl acetate, ethylene propylene diene monomer (EPDM), polyethylene oxide (PEO), styrene butyl rubber (SBR) or water soluble binder such as alginates or carboxymethyl cellulose (CMC).

In accordance with another aspect of the present disclosure, a method of manufacturing a composite electrode includes: combining active electrode material, an electrically conductive material, a binder, and a microporous ionically conducting solid in a solvent to form a mixture; mixing the mixture to form a composite slurry; coating the composite slurry on a current collector; and drying the coated current collector.

In some embodiments, the method further includes dissolving the binder in a solvent prior to the combination step.

In some embodiments, the mixing is performed at a temperature of 15-140° C.; and the composite slurry is cooled prior to coating on the current collector.

The foregoing and other features of the invention are hereinafter described in greater detail with reference to the accompanying drawings.

### BRIEF DESCRIPTION OF DRAWINGS

FIG. 1 is a schematic illustration of an exemplary composite electrode in accordance with the present disclosure.

FIG. 2 is a graph showing the change in viscosity with respect to time in a low viscosity composite slurry including a sodium-ion transition metal oxide, carbon black, polyvinylidene fluoride (PVDF) in N-Methylpyrrolidone (NMP), and 0.7% zeolite A additive; as well as for a low viscosity composite including a sodium-ion transition metal oxide, carbon black, and PVDF in NMP, without 0.7% zeolite A additive.

FIG. 3 is a graph showing the change in viscosity with respect to time in a high viscosity composite slurry including a sodium-ion transition metal oxide, carbon black, PVDF in NMP, and 0.7% zeolite A additive; as well as for a high viscosity composite slurry including a sodium-ion transition metal oxide, carbon black, and PVDF in NMP, without 0.7% zeolite A additive.

FIG. 4 is a flow chart showing an exemplary composite slurry and composite electrode manufacturing method.

FIG. 5 is a scanning electron microscope (SEM) image of a hard carbon anode electrode containing zeolite A additions.

FIG. 6 is a SEM image of a hard carbon anode electrode containing zeolite A additions.

FIG. 7 is a SEM image of a Sn, carbon composite anode with ZSM nano zeolite additions.

### DETAILED DESCRIPTION OF INVENTION

Hereinafter, the embodiments of the present disclosure will be described with reference to the accompanying tables and figures.

In accordance with the present disclosure, a composite electrode is provided that includes an active electrode material, conductive matrix (including one or more types of electrically conductive materials), and a microporous ionically conducting material. The composite electrode may include a current collector and may be used in an electrochemical cell, lithium-ion battery, sodium-ion battery, or other energy storage device.

In addition, a composite slurry is provided that includes an active electrode material, conductive matrix material (including one or more types of electrically conductive materials), and microporous ionically conducting material, said components dispersed in a solvent. The composite electrode may be formed from the composite slurry. It is noted that while this composition is referred to herein as a “composite slurry,” the composite slurry may alternatively be referred to as a “composite ink” or “composite paste.” The term “composite slurry” is intended to refer herein to compositions having any given viscosity, but alternatively, compositions with a relatively low viscosity may also be referred to as a “composite ink.” Similarly, compositions with a relatively high viscosity may also be referred to as a “composite paste.”

Advantageously, the incorporation of the microporous ionically conducting material into the composite electrode may improve the observed electrochemical properties thereof. Also, for active materials in which a large volume expansion is observed in between charge and discharge, the microporous ionically conducting material may also have the added benefit of buffering the volume expansion in the electrodes, and the presence thereof may help to maintain an ionic conducting pathway in the electrodes as the porosity decreases.

The incorporation of the microporous ionically conducting material may provide the surprising effect of increasing the stability of the composite slurry by stabilising the viscosity of the composite slurry over time. The incorporation of the microporous ionically conducting material may also reduce the observed viscosity of the composite slurry. This effect is observed, in particular, for composite slurries that include cathode materials which contain highly alkaline and moisture sensitive materials.

Lithium-ion cells are often constructed in a dry room, this is because the materials used to make a lithium-ion cell may absorb water and water is detrimental to the performance of a non-aqueous electrochemical cell. Although preferably the cathode coatings will be performed in a dry atmosphere, this is often not the case and the electrodes may be coated outside a dry room atmosphere and then subsequently dried to remove any water before transferring to a dry room. For many lithium-ion containing materials the maximum temperature for drying is adequate to remove the absorbed water. However sodium-ion cathodes can be much more reactive to water compared to the lithium counterparts. The sodium-ion containing materials may either decompose, or may also chemically intercalate water into the structure. Therefore the temperatures used for drying (e.g., up to about 140° C.) are not adequate to remove the chemically bound water or reverse the decomposition process.

In addition to material stability, the absorbed and adsorbed water can have a negative effect upon the properties of a slurry, and in basic environments gelling of the binding agent contained within the slurry may occur. Sodium is much more basic than the lithium layered oxides and therefore stability of the slurries can be a problem with these materials. In particular, the slurries increase in viscosity over time and gelation may eventually occur.

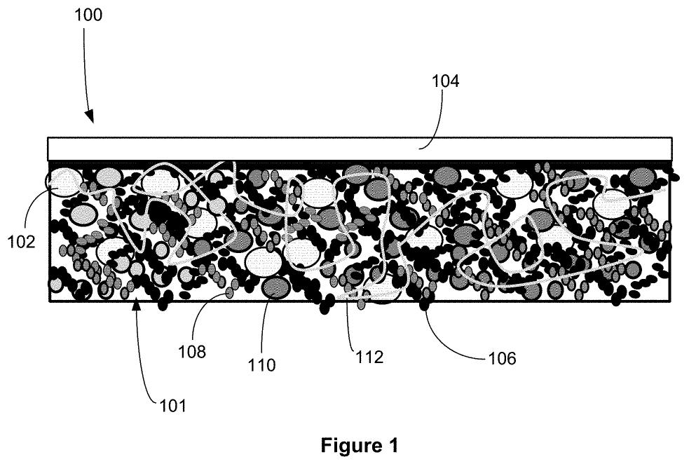

With reference to FIG. 1, a composite electrode including the microporous ionically conductive material is shown at 100. The composite electrode 100 includes a conductive matrix 101 (including one or more types of electrically conductive materials) and a plurality of materials disposed in the conductive matrix 101. In the embodiment shown, the conductive matrix 101 includes a combination of conductive materials 106, 108. In other embodiments, only one type of conductive material may be included in the conductive matrix 101. In other embodiments, more than two types of conductive materials may be included in the conductive matrix 101. One or more active electrode materials 102, (e.g., negative or positive active electrode material) and one or more microporous ionically conducting materials 110 are dispersed in the conductive matrix 101. In some embodiments, the conductive matrix 101 includes one or more binders 112, such as a polymeric binder. The binder(s) 112 may bind the electrically conductive material(s), active electrode material(s), and microporous ionically conducting material(s) together. The electrically conductive material(s), active electrode material(s), microporous ionically conducting material(s), and binder(s) are shown as being coated on a current collector 104.

In some embodiments, the active electrode material is a positive active electrode material. The positive active electrode material may be a metal intercalation constituent that, upon charging of the electrode, de-intercalates metal ions. Exemplary positive active electrode materials include lithium or sodium layered oxides such as Li₁₋ₓMO₂, LiMO₂, Na₁₋ₓMO₂, NaMO₂, Na_{7/6}M_{5/6}O₂, Na₂MSiO₄, Li₂FeS₂, NaNiO₂, LiFeO₂, lithium iron borate, or a mixture thereof. In the above examples, M may be Cu, Zn, Mg, Al, Co, Ni, Fe, Mn, Ti, Sn, Zr or a mixture thereof, and x≥0. Other exemplary embodiments include layered phosphates or layered sulfates.

In other embodiments, the active electrode material is a negative active electrode material. Exemplary negative active electrode materials include metal alloy or conversion materials such as silicon, germanium, tin, metal oxides, metal sulphides, hard carbon, graphite, antimony, nickel-tin, tin-antimony, or mixtures thereof.

In some embodiments, the one or more active materials may be collectively present in an amount such that 50 wt % to 95 wt % of the composite electrode is active material. In other embodiments, the one or more active materials may be present in an amount such that 60 wt % to 90 wt % of the composite electrode is active material. In other embodiments, the one or more active materials may be present in an amount such that 80 wt % to 90 wt % of the composite electrode is active material. In other embodiments, the one or more active materials may be present in an amount such that 55 wt % to 65 wt % of the composite electrode is active material.

Exemplary electrically conductive materials include carbon black, graphite, carbon nanotube, single wall carbon nanotube, multi wall carbon nanotube, carbon fibre, graphene, titanium carbide, and copper or silver particles. The one or more electrically conductive materials may also be referred to herein as electrically conductive additives. In some embodiments, the average diameter of the electrically conductive materials can be nano-sized (e.g., 1 nm) up to about 5 microns. In some embodiments, the one or more electrically conductive materials may collectively total up to about 20 wt % of the formed composite electrode. As an example, the one or more electrically conductive materials may be collectively present in an amount of about 0.1 wt % to about 20 wt % of the composite electrode. As another example, the one or more electrically conductive materials may be collectively present in an amount of about 0.1 wt % to about 15 wt % of the composite electrode. As another example, the one or more electrically conductive materials may be collectively present in an amount of about 0.1 wt % to about 10 wt % of the composite electrode. In some embodiments, the composite electrode includes one type of electrically conductive material. In other embodiments, the composite includes more than one type of electrically conductive component. For example, in the embodiment shown in FIG. 1, the composite electrode includes two different electrically conductive components. In other examples, the composite electrode may include more than two different electrically conductive materials. In some embodiments where the composite includes more than one electrically conductive material, each electrically conductive material may be present in an amount of about 1 wt % to about 10 wt %.

Exemplary microporous ionically conducting materials include hydrophobic or hydrophilic powders such as hydrophobic porous nano silica, hydrophobic porous nano alumia, hydrophobic zeolites, zeolites, nano zeolites or a clathrate. Exemplary zeolite types include zeolite A, sodalite, ABW , ANA (Analcime), CAN (Cancrinite), CHA (Chabasite), ERI (Erionite), FAU (Faujasite), GIS (Gismondite), GME (Gmelinite), HEU (Heulandite) MOR (Mordenite), NAT (Natrolite), PHI (Phillipsite), SOD (Sodalite), and molecular organic frameworks (MOF). The microporosity of zeolites is caused by their cage structure. In some embodiments, the cage size of the one or more zeolites utilized as the microporous ionically conducting material(s) is about 3 to about 5 Angstrom. In some embodiments, the one or more microporous ionically conducting materials may collectively total up to about 10 wt % of the composite electrode. As an example, the one or more microporous ionically conducting materials may be collectively present in an amount of about 0.1 wt % to about 10 wt % of the composite electrode. As another example, the one or more microporous ionically conducting materials may be collectively present in an amount of about 0.5 wt % to about 10 wt % of the composite electrode. As another example, the one or more microporous ionically conducting materials may be collectively present in an amount of about 0.7 wt % to about 5 wt % of the composite electrode.

In some embodiments, the conductive matrix includes one or more binders. In other embodiments, a binder may be omitted from the conductive matrix (e.g., in the composite slurry and composite electrode formed therefrom). In those embodiments that include binder, one example of a suitable binder is a polymeric binder. Exemplary polymeric binders include the polymers poly vinylidene fluoride (PVDF), poly vinyl chloride (PVC), poly acrylic acid (PAA), polyvinylpyrrolidone (PVP), polyvinyl alcohol (PVA), polyvinyl acetate, ethylene propylene diene monomer (EPDM), polyethylene oxide (PEO), styrene butyl rubber (SBR) or water soluble binder such as alginates or carboxymethyl cellulose (CMC). In some embodiments, the one or more binders may collectively total up to about 30 wt % of the composite electrode. As an example, the one or more binders may be collectively present in an amount of about 1 wt % to about 30 wt % of the composite electrode. As another example, the one or more binders may be collectively present in an amount of about 2 wt % to about 20 wt % of the composite electrode. As another example, the one or more binders may be collectively present in an amount of about 5 wt % to about 15 wt % of the composite electrode. As another example, the one or more binders may be collectively present in an amount of about 5 wt % to about 10 wt % of the composite electrode.

Another aspect of the present disclosure relates to a composite slurry which includes the one or more active electrode materials, conductive matrix material, and ionically conducting microporous solid, which is dispersed in a solvent. The composite slurry may be used to produce the composite electrode.

Exemplary solvents include trimethyl benzene (TMB) N-Methyl-2-pyrrolidone (NMP), hexanol, hexane, xylene, ethanol, isopropyl alcohol (IPA), acetonitrile, dimethyl sulfoxide (DMSO), dimethyl ether (DME), carbonate solvents such as propylene carbonate, ethylene carbonate, dimethyl carbonate, methanol, and dodecanol. In some embodiments, the solvent may be present in an amount such that the solid content of the composite slurry is 30% to 60%. In other embodiments, the solvent may be present in an amount such that the solid content of the composite slurry is 40% to 60%. In other embodiments, the solvent may be present in an amount such that the solid content of the composite slurry is 40% to 50%.

The slurry may be produced in a manner such that the viscosity is provided in a desired range. As an example, for lower viscosity composite slurries, the viscosity of the slurry may have an as-mixed viscosity of 100 to 150 mPa s. As another example, for higher viscosity composite slurries, the viscosity of the slurry may have an as-mixed viscosity of 1 to 10 Pa s. Other viscosities may be provided depending, for example, on the amount of solvent combined with the one or more electrically conductive materials, one or more microporous ionically conductive materials, and one or more active materials.

The inventors have found that the slurry can be stabilised for an extended period of time with a small amount of the microporous ionically conductive material added into the composite slurry. In an example, in some embodiments, the composite slurry can be stabilised for up to 260 minutes with the microporous ionically conductive material present in an amount as little as 0.7 wt % of the formed composite electrode. This addition may significantly improve the time at which the slurry is stable and allows for more even and reliable coatings for cell manufacture. Advantageously, the composite slurry may have an improved stability to oxidation in air and decomposition due to water in the air. Another advantage is the that the formed composite electrode may also be stabilised to decomposition in air due to water.

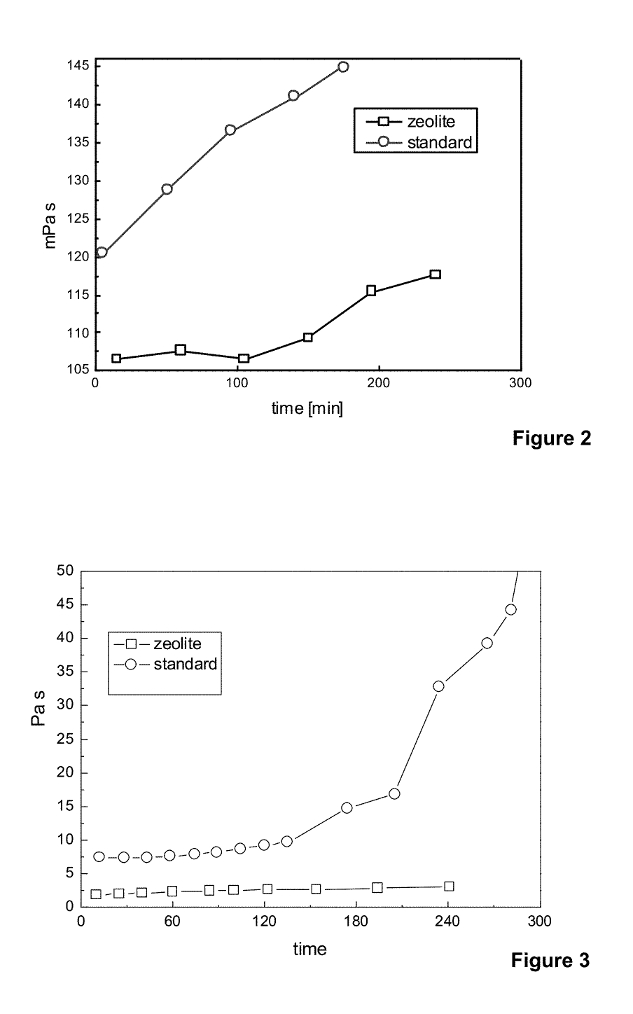

As an example, FIG. 2 shows the change in viscosity with respect to time in a low viscosity composite slurry including sodium-ion transition metal oxide, carbon black, PVDF in NMP, and 0.7% zeolite A additive; as well as for a low viscosity composite slurry including a sodium-ion transition metal oxide, carbon black, and PVDF in NMP, without 0.7% zeolite A additive. It is observed that the viscosity of the composite slurry with no zeolite additive is higher than that with zeolite additive. Over time, the composite slurry with no additive increases sharply from 120 mPas to 145 mPas over 200 minutes whereas the zeolite addition paste is stable over 2 hrs at 105 mPas and increases to 115 mPas after 200 min.

As another example, FIG. 3 shows the change in viscosity with respect to time in a high viscosity composite electrode slurry including sodium ion transition metal oxide, carbon black, PVDF in NMP, and 0.7% zeolite A additive; as well as for a high viscosity composite slurry including a sodium-ion transition metal oxide, carbon black, and PVDF in NMP, without 0.7% zeolite A additive. Both of these composite slurries include standard ink 91% sodium layered metal oxide: 1% MWCNT:3% C65:5% PVDF, with a solid content of 49%. For the composite electrode slurry including the zeolite A additive, 0.7% zeolite 3 Å is added. Both mixtures were made in a planetary, centrifugal Thinky mixer at 2000 rpm for 10 mins and 2200 rpm for 3 mins. Measurements were taken by a viscometer using a spindle 29 and measurement taken after 3 mins of rotation at temperatures of 19-21° C. It is observed that the viscosity of the ink increases for both mixes, however the viscosity for the ink which does not contain the zeolite increases slowly from 7.5 Pas to 10 Pas over two hours, the viscosity rises sharply after two hours and 35 Pas is observed after 4 hours. For the zeolite containing composite slurry, the viscosity rises slowly from 2 to 2.5 Pas over the 4 hours.

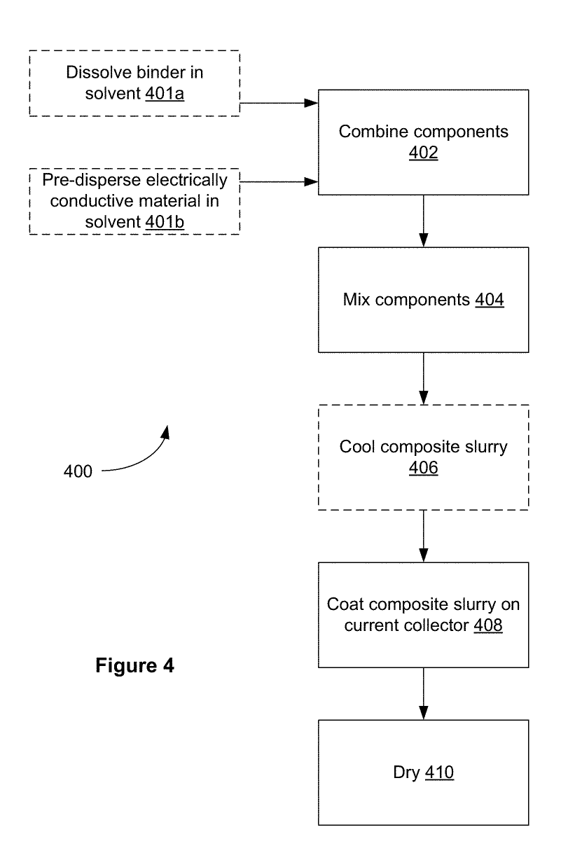

FIG. 4 is a flow chart showing an exemplary method for manufacturing a composite slurry and for forming a composite electrode therefrom.

At step 402, the one or more electrically conductive materials, the one or more microporous ionically conductive materials, and the one or more active materials are combined in a solvent. In embodiments where binder is included, the binder may be combined at this point. The components may be combined in any suitable amount, for example, to optimize the properties of the formed electrode such as adhesion, resistivity, and porosity. Mixing may be performed at room temperature (e.g., 20° C.-30° C.) or at an elevated temperature (e.g., 50° C.-100° C.).

In some embodiments, the one or more active materials may be present in the mixture in an amount such that 50 wt % to 95 wt % of the formed composite electrode is active material. In other embodiments, the one or more active materials may be present in the mixture in an amount such that 60 wt % to 90 wt % of the formed composite electrode is active material. In other embodiments, the one or more active materials may be present in the mixture in an amount such that 80 wt % to 90 wt % of the formed composite electrode is active material. In other embodiments, the one or more active materials may be present in the mixture in an amount such that 55 wt % to 65 wt % of the formed composite electrode is active material.

In some embodiments, the one or more binders may be present in the mixture in an amount such that 1 wt % to 30 wt % of the formed composite electrode is binder. In other embodiments, the one or more binders may be present in the mixture in an amount such that 2 wt % to 20 wt % of the formed composite electrode is binder. In other embodiments, the one or more binders may be present in the mixture in an amount such that 5 wt % to 15 wt % of the formed composite electrode is binder. In other embodiments, the one or more binders may be present in the mixture in an amount such that 5 wt % to 10 wt % of the formed composite electrode is binder.

In some embodiments, the one or more microporous ionically conducting materials may be present in the mixture in an amount such that 0.1 wt % to 10 wt % of the formed composite electrode is microporous ionically conducting material. In other embodiments, the one or more microporous ionically conducting materials may be present in the mixture in an amount such that 0.5 wt % to 10 wt % of the formed composite electrode is microporous ionically conducting material. In other embodiments, the one or more microporous ionically conducting materials may be present in the mixture in an amount such that 0.7 wt % to 5 wt % of the formed composite electrode is microporous ionically conducting material.

In some embodiments, the one or more electrically conductive materials may be present in the mixture in an amount such that 0.1 wt % to 20 wt % of the formed composite electrode is electrically conductive material. In other embodiments, the one or more electrically conductive materials may be present in the mixture in an amount such that 0.1 wt % to 15 wt % of the formed composite electrode is electrically conductive material. In other embodiments, the one or more electrically conductive materials may be present in the mixture in an amount such that 0.1 wt % to 10 wt % of the formed composite electrode is electrically conductive material.

In some embodiments, the solvent may be present in an amount such that the solid content of the composite slurry is 30% to 60%. In other embodiments, the solvent may be present in an amount such that the solid content of the composite slurry is 40% to 60%. In other embodiments, the solvent may be present in an amount such that the solid content of the composite slurry is 40% to 50%. Mixing or dispersing the materials in the solvent may be with or without a surfactant. Exemplary surfactants include Tergitol, Triton X, DDBS, and PVP. In some embodiments, one or more of the components may be pre-mixed and/or pre-dispersed in a solvent prior to the combination step at 402. Accordingly, optionally at step 401a, the binder (when included in the formed composite slurry) may be dissolved in a solvent. The amount of solvent used to dissolve the binder may depend on the solid content of the binder. As an example, the pre-mixture/pre-dispersion prepared at step 401a may include up to 20% solid content of binder. Mixing may be performed at room temperature (e.g., 20° C.-30° C.) or at an elevated temperature (e.g., 50° C.-140° C.). Mixing or dispersing the materials in a solvent may be with or without a surfactant. Exemplary surfactants include Tergitol, Triton X, DDBS, and PVP. Mixing may be conducted, for example, via planetary mixing or via a hot stirring plate. In some embodiments, performing the pre-mixing or pre-dispersing in step 401a may reduce the formation agglomerates that may be formed in step 404.

Also, optionally at step 401b, the one or more electrically conductive materials may be pre-dispersed in solvent. The amount of solvent used to dissolve the one or more electrically conductive materials may depend on the solid content of the one or more electrically conductive materials. As an example, the pre-mixture/pre-dispersion prepared at step 401b may include up to 20% solid content of electrically conductive material. Mixing may be performed at room temperature (e.g., 20° C.-30° C.) or at an elevated temperature (e.g., 50° C.-140° C.). Mixing or dispersing the materials in a solvent may be with or without a surfactant. Exemplary surfactants include Tergitol, Triton X, DDBS, and PVP. Mixing may be conducted, for example, via planetary mixing, a hot stirring plate, or ultrasonic homogeniser. In some embodiments, performing the pre-mixing or pre-dispersing in step 401b may reduce the formation agglomerates that may be formed in step 404.

At step 404, the mixture is mixed. Exemplary types of mixing include shear mixing, asymmetric dual planetary mixing, ball milling, paddle mixing, homogenising or ultrasonic mixing. The mixture constitutes the composite slurry.

The mixture may be mixed for any suitable time. In some embodiments, the mixing is conducted for a time long enough for the components to be homogeneously mixed. As an example, the time for mixing may be between 5 minutes and 12 hours. In another example, the time for mixing may be between 5 minutes and 60 minutes. In another example, the time for mixing may be between 10 minutes to 15 minutes.

Mixing may take place at room temperature (e.g., 20-30° C.), or at elevated temperatures (e.g., 50-140° C.). In embodiments where the mixing at step 404 is performed at elevated temperatures, or in embodiments where the mixing causes a rise in temperature of the mixture, the formed composite slurry may be left to cool for a predetermined period of time. Accordingly, optionally at step 406, the formed composite slurry may be left too cool. In some examples, cooling may be conducted by passively allowing the formed composite slurry to cool to room temperature (e.g., 20° C.-30° C.) or to a desired temperature. In other examples, the formed composite slurry may be cooled to a desired temperature (e.g., 20° C.-30° C. or to a different desired temperature) using refrigeration. In other embodiments, the formed composite slurry may be subsequently processed (e.g., coated on a substrate) while at an elevated temperature and without being left to cool.

At step 408, the formed composite slurry is coated onto a current collector. As an example, the current collector may be carbon coated aluminium, carbon coated copper, aluminium, copper or stainless steel foil, mesh, foam, or plate. The formed composite slurry may be applied by a technique such as the doctorblade technique, spraycoating, dip coating, spin coating, pressing.

At step 410, the coated current collector is dried to remove residual solvent. Drying may be conducted, for example, in a vacuum oven. The time and temperature for drying may be any suitable time and temperature that allows for removal of the residual solvent while maintaining the integrity of the coating. As an example, drying may be conducted for 30 minutes to 1 day. As another example, drying may be conducted for 2 hours to 8 hours. As an example, drying may be conducted at a temperature of 60-200° C. As another example, drying may be conducted at a temperature of 70-150° C. In one exemplary embodiment, drying is conducted at a temperature of 70° C.-140° C. for a time of 30 minutes to 3 hours. In some embodiments, the coated current collector may be subsequently stored at an elevated temperature (e.g., about 80° C.) to ensure that they remain dry.

### EXAMPLES

### Example 1

### Composite Cathode with Sodium Ion Cathode

To prepare a sodium ion cathode electrode, a binder solution of polyvinylidene fluoride (PVDF) in N-Methylpyrrolidone (NMP) at 5% w/w PVDF content, and a 10% w/w dispersion of carbon black (C65—Timcal) in NMP is first made. Portions of these mixes are combined with a 3 Å cage zeolite A (sigma-aldrich) and NaNi_{1/2}Mn_{1/4}Sn_{1/8}Ti_{1/8}O₂ cathode material so that the proportions of the active material:conductive carbon:binder:microporous ionically conducting material is 89:5:5:1 by weight in the final electrode. This composite is then mixed using a planetary, centrifugal Thinky mixer for 10 minutes at 1100 rpm, followed by two minutes at 1700 rpm for degassing. The slurry is then cast onto an aluminium current collector using the Doctor-blade technique. The formed cast electrode is then dried under Vacuum at about 80-120° C. for about 4 hours. As formed, each electrode film contains the following components, expressed in percent by weight: 89% active material, 5% Super P carbon, and 6% PVDF binder 1% zeolite A.

### Example 2

### Composite Cathode with Li₂FeS₂

To prepare a lithium ion cathode electrode, a binder solution of polyethylene oxide (PEO) in trimethyl benzene (TMB) at 5% w/w PEO content, and a 15% w/w paste of carbon black (C65—Timcal) in TMB is first made. Portions of these mixes are combined and a Aluminosilicate, mesostructured MCM-41 (sigma Aldrich) and carbon nano tubes (CNT) are added to Li₂FeS₂ cathode material so that the proportions of the active material:conductive carbon:CNT:binder:microporous ionically conducting material is 89:4:1:5:1 by weight in the final electrode. This composite is then mixed using a dual asymmetric mixer (Thinky) for 10 minutes at 1100 rpm. The slurry is then cast onto an aluminium current collector using the Doctor-blade technique. The formed cast electrode is then dried under Vacuum at about 80-120° C. for about 4 hours. As formed, each electrode film contains the following components, expressed in percent by weight: 89% active material, 5% C65 P carbon, and 6% PEO binder 1% MCM-41.

### Example 3

### Composite Anode with Hard Carbon

To prepare a sodium ion composite anode, a binder solution of PVDF in NMP at 10% w/w PVDF content, and a 10% w/w dispersion of carbon black (C65—Timcal) in NMP are mixed with commercial available hard carbon material and 3 Å cage zeolite A (sigma-aldrich) so that the proportions of the active material:conductive carbon:binder:microporous ionically conducting material is 85:5:7.5:2.5 by weight in the final electrode. This composite is then mixed using a planetary, centrifugal Thinky mixer for 10 minutes at 2000 rpm, followed by a three minute degassing step at 2200 rpm. The slurry is then cast onto an aluminium current collector using the Doctor-blade technique. The formed cast electrode is predried and moved into a Vacuum oven at about 80-120° C. for about 2 hours to dry any NMP residues off. As formed, each electrode film contains the following components, expressed in percent by weight: 85% active material, 7.5% C65 P carbon, and 5% PVDF binder 2.5% zeolite A.

### Example 3a

### Composite Anode with Hard Carbon

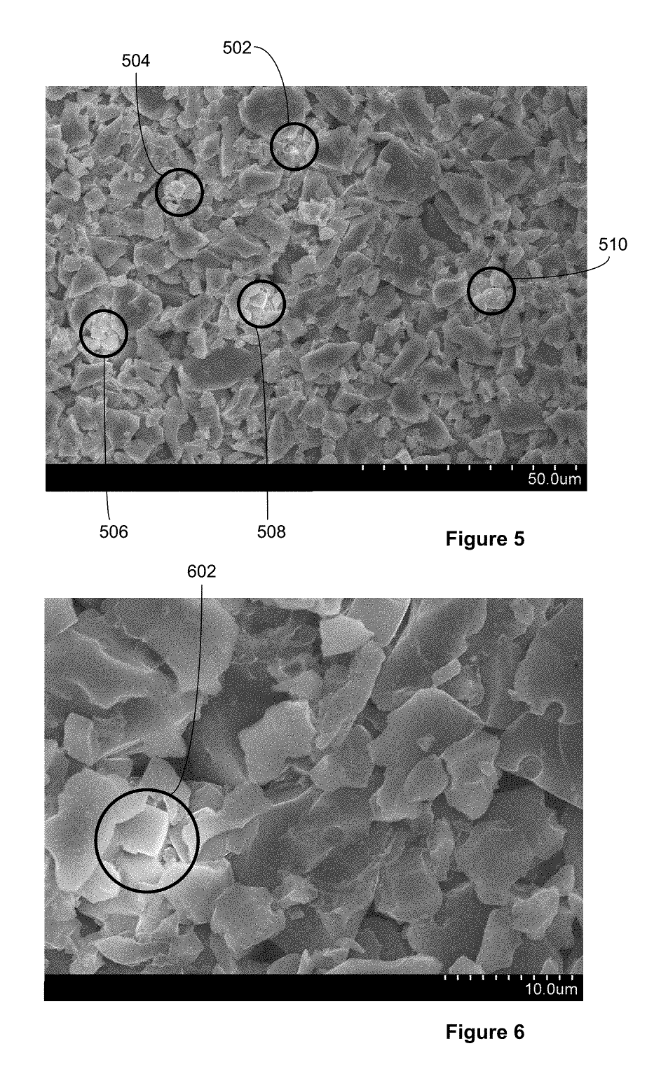

FIGS. 5 and 6 are SEM pictures of a hard carbon anode electrode containing zeolite A additions. SEM pictures of Hard Carbon electrodes, containing Hard carbon (particle size approx. 9 μm), Binder (PVDF) and Zeolite A. The composite anode is prepared in the same manner as described in Example 3, but without the addition of C65 P carbon. The circled areas 502, 504, 506, 508, 510, 602 respectively shown in FIGS. 5 and 6 highlight the positions of the cubic zeolite, of size approximately 5 μm³. Low levels of the zeolite additive show improved electrode properties in terms of consistency and slurry stability.

### Example 4

### Composite Anode with Nano Sn

To prepare a sodium ion negative electrode containing tin as the active material, PAA (average Mw=1.25 million g mol⁻¹, Sigma Aldrich) is dissolved in NMP to form a 1.5% w/w binder solution and a 10% w/w dispersion of carbon black (C45—Timcal) in NMP is made. Portions of the binder solution and carbon black dispersion are added to pre-weighed dry powders of tin nanoparticles (US Research Nanomaterials Inc.), graphite (KS6L—Timcal) and Nano ZSM-5-H (ACS Material). The materials are weighed so that the ratio of the components (active material:conductive carbon:binder:microporous ionically conducting material) in the final electrode is 60:20:10:10 by weight. Mixing of the slurry is achieved by the use of a stand homogenizer followed by an ultrasonic probe. The slurry is then cast onto an aluminium current collector using the Doctor-blade technique. The formed cast electrode is then dried under Vacuum at about 80-120° C. for about 4 hours.

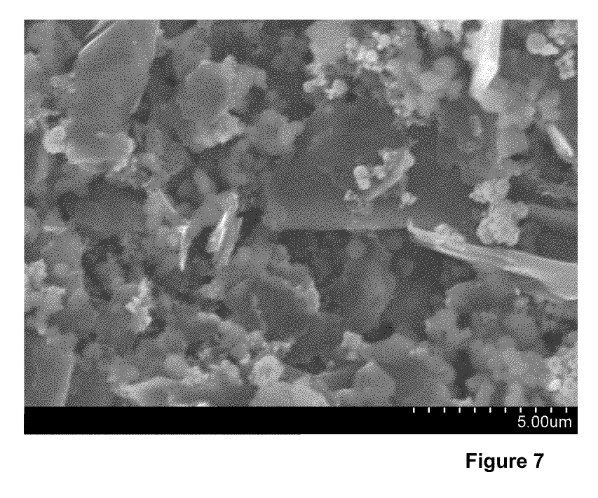

FIG. 7 is a SEM picture of the composite anode produced in accordance with Example 4. A nano Sn, Graphite and zeolite composite is shown.

### Example 5

### Composite Anode with Silicon

To prepare a lithium ion negative electrode containing silicon as the active material, Carboxymethyl cellulose CMC is dissolved in water to form a 5% w/w binder solution, and a 10% w/w dispersion of carbon black (C45—Timcal) in water is made. Portions of the binder solution and carbon black dispersion are added to pre-weighed dry powders of silicon nanoparticles, graphite (KS6L—Timcal) and Zeolite A (sigma aldrich). The materials are weighed so that the ratio of the components (active material:conductive carbon:binder:microporous ionically conducting material) in the final electrode is 60:20:10:10 by weight. Mixing of the slurry is achieved by the use of a stand homogenizer followed by an ultrasonic probe. The slurry is then cast onto an aluminium current collector using the Doctor-blade technique. The formed cast electrode is then dried under Vacuum at about 80-120° C. for about 4 hours.

### INDUSTRIAL APPLICABILITY

The composite electrodes of the present disclosure are suitable for use in many different applications, energy storage devices, rechargeable batteries, electrochemical devices and electrochromic devices.

1. A composite electrode, comprising:
a conductive matrix, comprising:
an electrically conductive material; and
a binder;
an active electrode material dispersed in the conductive matrix; and
a microporous ionically conducting solid dispersed in the conductive matrix.

2. The composite electrode of claim 1, wherein the active electrode material comprises a lithium or sodium layered oxide.

3. The composite electrode of claim 1, wherein the active electrode material comprises silicon, germanium, tin, metal oxide, metal sulphide, hard carbon, graphite, antimony, nickel-tin, or tin-antimony.

4. The composite electrode of claim 1, wherein the active electrode material is present in an amount of 50 wt % to 95 wt % of the composite electrode.

5. The composite electrode of claim 1, wherein the microporous ionically conducting solid comprises a zeolite.

6. The composite electrode of claim 1, wherein the microporous ionically conducting solid comprises a clathrate.

7. The composite electrode of claim 1, wherein the microporous ionically conducting solid comprises porous nano silica.

8. The composite electrode of claim 1, wherein the microporous ionically conducting solid comprises porous nano alumina.

9. The composite electrode of claim 1, wherein the microporous ionically conducting solid comprises a molecular organic framework material.

10. The composite electrode of claim 1, wherein the microporous ionically conducting material is present in an amount of 0.1 wt % to 10 wt % of the composite electrode.

11. The composite electrode of claim 1, wherein the binder comprises poly vinylidene fluoride (PVDF), poly vinyl chloride (PVC) poly acrylic acid (PAA), polyvinylpyrrolidone (PVP), polyvinyl alcohol (PVA), polyvinyl acetate, ethylene propylene diene monomer (EPDM), polyethylene oxide (PEO), styrene butyl rubber (SBR) or water soluble binder such as alginates or carboxymethyl cellulose (CMC).

12. A composite slurry, comprising:
a solvent;
a conductive matrix dispersed in the solvent, the conductive matrix comprising:
an electrically conductive material; and
a binder;
an active electrode material dispersed in the solvent; and
a microporous ionically conducting solid dispersed in the solvent.

13. The composite slurry of claim 12, wherein the active electrode material comprises a lithium or sodium layered oxide.

14. The composite slurry of claim 12, wherein the active electrode material comprises silicon, germanium, tin, metal oxide, metal sulphide, hard carbon, graphite, antimony, nickel-tin, or tin-antimony.

15. The composite slurry of claim 12, wherein the microporous ionically conducting solid comprises a zeolite.

16. The composite slurry of claim 12, wherein the microporous ionically conducting solid comprises a clathrate.

17. The composite slurry of claim 12, wherein the binder comprises poly vinylidene fluoride (PVDF), poly vinyl chloride (PVC) poly acrylic acid (PAA) polyvinylpyrrolidone (PVP), polyvinyl alcohol (PVA), polyvinyl acetate, ethylene propylene diene monomer (EPDM), polyethylene oxide (PEO), styrene butyl rubber (SBR) or water soluble binder such as alginates or carboxymethyl cellulose (CMC).

18. A method of manufacturing a composite electrode, comprising:
combining active electrode material, an electrically conductive material, a binder, and a microporous ionically conducting solid in a solvent to form a mixture;
mixing the mixture to form a composite slurry;
coating the composite slurry on a current collector; and
drying the coated current collector.

19. The method of claim 18, further comprising dissolving the binder in a solvent prior to the combination step.

20. The method of claim 18, wherein:
the mixing is performed at a temperature of 15-140° C.; and
the composite slurry is cooled prior to coating on the current collector.
